(19) United States
(12) Patent Application Publication
(10) Pub. No.: US 2025/0368304 A1
(43) Pub. Date: Dec. 4, 2025

(54) ACOUSTIC NAVIGATIONAL AID SYSTEM AND METHOD

(71) Applicant: DeepWater Buoyancy, Inc., Biddeford, ME (US)

(72) Inventors: Harold T VINCENT, II, North Kingstown, RI (US); David A CAPOTOSTO, Biddeford, ME (US)

(21) Appl. No.: 18/877,976

(22) PCT Filed: Jun. 22, 2023
(86) PCT No.: PCT/US2023/068865

§ 371 Date: Dec. 20, 2024

Related U.S. Application Data
(60) Provisional application No. 63/354,333, filed on Jun. 22, 2022.

(51) Int. Cl. B63B 49/00; G01C 21/20; G01S 5/30; G01S 15/87

(52) U.S. Cl. CPC B63B 49/00; G01C 21/203; G01S 5/30; G01S 15/874; G01S 2205/04

(57) ABSTRACT

Disclosed herein are systems and methods for acoustic navigation. The acoustic navigation system includes a surface component installed on a vessel and a subsurface component positioned on the seafloor. The surface component includes acoustic transducer and acoustic transceiver units configured to generate and transmit an omnidirectional acoustic interrogation signal and directionally receive acoustic reply signals. The subsurface component includes a plurality of seafloor platforms placed at known geodetic locations on the seafloor. Each seafloor platform includes an acoustic transducer unit and an acoustic signal processing unit and is configured to receive and process the acoustic interrogation signals and generate and transmit an omnidirectional acoustic reply signal. The surface component is further configured to receive and process the acoustic reply signals, to calculate the geodetic location and heading of the vessel, and to display the geodetic location and heading information on a human machine interface.

### CROSS-REFERENCE TO RELATED APPLICATIONS

This application claims the benefit of U.S. Provisional Application No. 63/354,333, filed Jun. 22, 2022, the disclosure of which is herein incorporated by reference.

### BACKGROUND

### 1. Field of the Invention

This invention pertains to the field of navigational aids. Specifically, this invention relates to novel acoustic navigational aid systems and methods that facilitate marine navigation regardless of the availability and reliability of traditional celestial, GPS, and map and compass navigation methods.

### 2. Discussion of Background Information

The problem of accurate marine navigation is well known. In particular, certain areas of the globe, such as the Arctic region, continue to present navigational challenges for mariners.

Determining a vessel's current location is critical to all navigational systems. However, when navigating some areas of the planet traditional navigation systems and techniques can become unreliable, leaving mariners without the ability to accurately determine their location. For example, navigating the Arctic region is fraught with difficulty. In addition to the high frequency of difficult weather conditions, mariners are faced with the reality that traditional navigational methods are often unreliable. Unlike other areas of the planet, the use of surface buoys to aid navigation in the Arctic is challenged by the presence of ice floes, which limit the practical use of surface buoys to a portion of the calendar year that includes the summer months and a portion of the shoulder seasons. Further, even when surface buoys are viable, the effectiveness of surface buoy systems is limited by visibility and the height of eye. Similarly, celestial navigational systems are reliant of weather conditions and require a clear view of the sky to determine a vessel's location.

In addition to visual navigational systems, traditional navigational instruments are often unreliable in Arctic regions. For example, magnetic compasses are notoriously inaccurate as they approach the magnetic pole, which renders compasses relatively useless as a marine navigational tool in the Arctic regions. Further, even GPS technology fails to provide a reliable alternative to navigation in the Arctic regions due to the location and orientation of existing GPS satellites and disturbances due to ionospheric activity.

In each instance, the unreliable nature of the traditional navigational methods in the Arctic compromises the ability of mariners to precisely determine their location, significantly increasing the likelihood of nautical accidents. Therefore, a need exists for an efficient navigational system and method that can reliably and accurately operate anywhere in the planet, including the Arctic regions.

### BRIEF DESCRIPTION OF THE DRAWINGS

These and other features, aspects and advantages of the present invention will become better understood with reference to the following description, appended claims, and accompanying drawings where:

FIG. 1 depicts an embodiment of the system showing the component subsystems.

FIG. 2A depicts an embodiment of an acoustic transducer unit of the system.

FIG. 2B depicts an embodiment of an acoustic transducer unit of the system.

FIG. 3 depicts an electronic flow diagram of an embodiment of an acoustic transceiver unit of the system.

FIG. 4 depicts a side view of an embodiment of a seafloor platform of the present invention.

FIG. 5 is a cross section view of an embodiment of a seafloor platform of the present invention.

FIG. 6 is a top view of an embodiment of a seafloor platform of the present invention.

FIG. 7 depicts a graphical representation of the geometry associated with the equations used in connection with method of the present invention.

FIG. 8 shows the steps of one method of the present invention.

### DETAILED DESCRIPTION OF THE INVENTION

The present invention is directed to the problems associated with marine navigation in areas where traditional navigational systems and methods are unreliable. Specifically, the present invention provides an acoustic navigation system and method that enables reliable and accurate marine navigation. Navigation systems of the present invention include both surface and subsurface components that utilize acoustic signaling to facilitate marine navigation.

Marine accidents can be costly in terms of their economic and environmental impacts. As the Arctic regions see increases in marine traffic, the potential for marine accidents increases. Thus, there is a significant need for navigational systems that can ensure safe, reliable navigation through the Arctic regions. The present system and method addresses problems surrounding marine navigation in areas where traditional navigational systems can be unreliable.

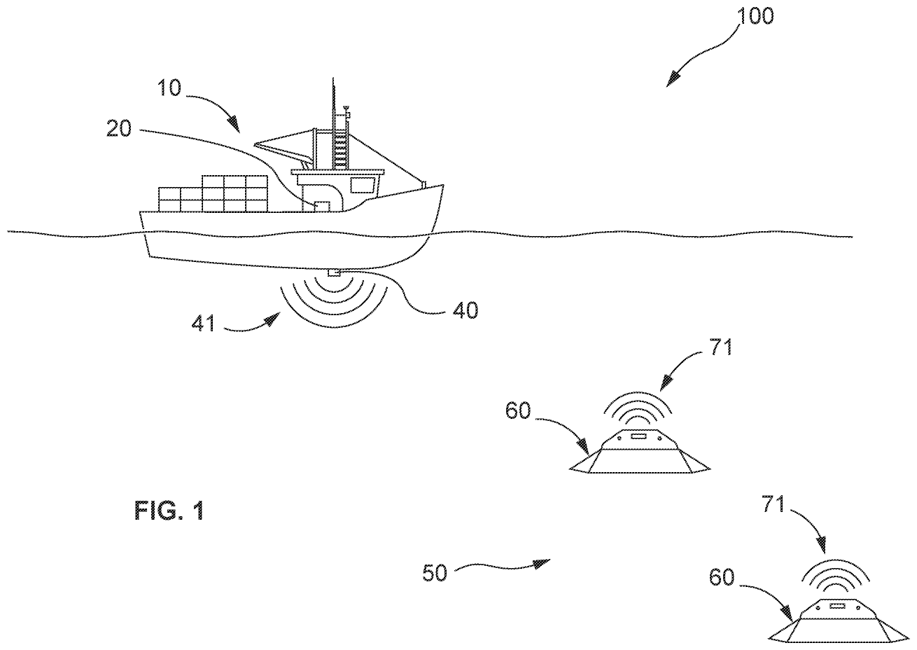

Turning to FIG. 1, an embodiment of the acoustic navigational system 100 of the present invention is shown. The acoustic navigation system 100 includes a surface component 10 located on a vessel and a subsurface component 50 comprising a plurality of seafloor platforms 60, with each seafloor platform 60 located at a known geodetic location on the seafloor. Communication between the surface component 10 and the subsurface component 50 is achieved using acoustic interrogation signals 41 transmitted by the surface component 10 and acoustic reply signals 71 transmitted by the subsurface component 60.

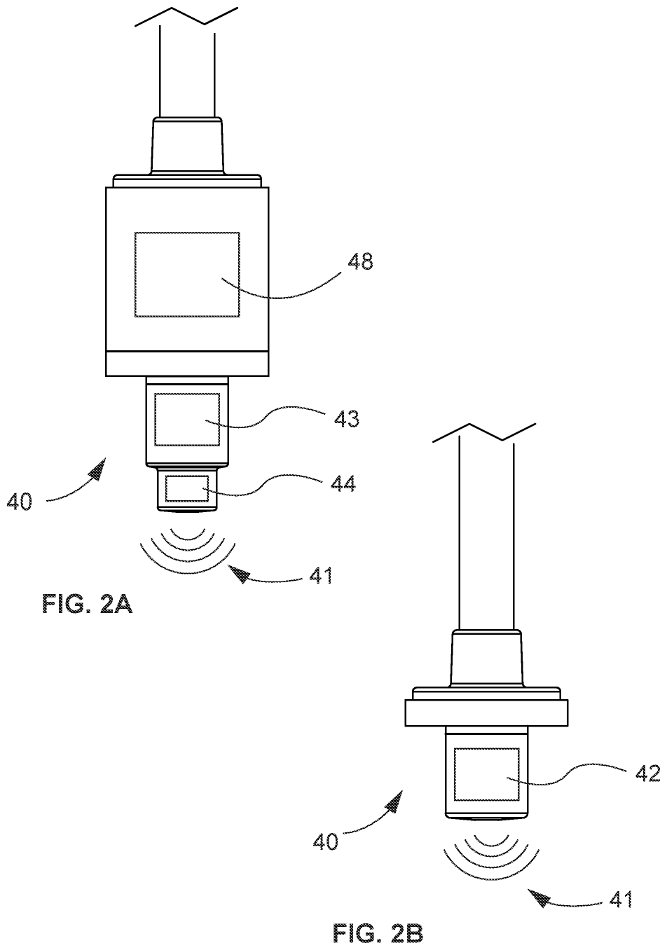

The surface component 10, which is located on a vessel traversing the surface of a body of water, comprises an acoustic transceiver unit 20 and an acoustic transducer unit 40. As best shown in FIGS. 2A and 2B, the acoustic transducer unit 40 includes at least one transducer 42, which converts the electronic signal passed from the acoustic transceiver unit 20 into an acoustic interrogation signal 41 that can be transmitted into the water. In embodiments where the acoustic transducer unit 40 comprises a single transducer 42, the transducer 42 performs the transmit function with regard to outgoing acoustic interrogation signals 41 and also the receive function with regard to incoming acoustic reply signals 71. In other embodiments, where the acoustic transducer unit 40 comprises two transducers 43, 44, a first transducer 44 performs the transmit function, and a second transducer 43 performs the receive function. Regardless of the number of transducers utilized in the acoustic transducer unit 40, the transmit function of the acoustic transducer unit 40 is omnidirectional to ensure that the acoustic interrogation signal 41 is transmitted to all seafloor platforms 60 within range of the surface component 10. In contrast, the receive function of the acoustic transducer unit 40 is directional. In some embodiments the acoustic transducer unit 40 is installed on the vessel and aligned such that the acoustic transducer unit 40 heading direction will coincide with the vessel heading direction. Further, the acoustic transducer unit 40 may include an acoustic reply signal 71 preamplifier 48 in some embodiments of the present invention.

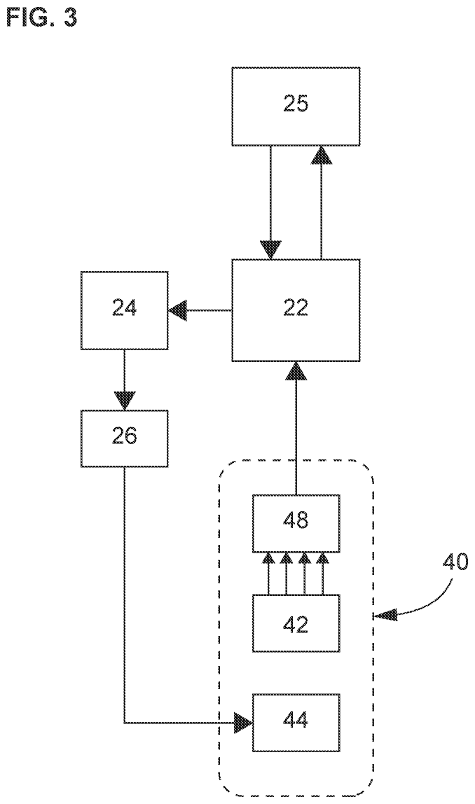

The acoustic transceiver unit 20 is comprised of a group of electronic components that control the operation of the acoustic navigation system 100 and provide interaction with the user. As depicted in FIG. 3, the electronic components of the acoustic transceiver unit 20 include a microcontroller 22, which may be comprised of one or more printed circuit boards. The microcontroller 22 performs the processing functions of the surface component 10, including generating electronic interrogation signals, processing incoming reply signals to ascertain pertinent details of the responding seafloor platform 60, and enabling the graphic representation of the details for the responding seafloor platform 60 on a human machine interface 25. In some embodiments, the microcontroller 22 also processes input from a user to control the acoustic navigation system 100. The microcontroller 22 is in electronic communication with a power amplifier 24 which amplifies the electronic signal received from the microcontroller 22 and passes it to a tuning component 26 prior to passing the tuned electronic signal to a transducer 42, 44 of the acoustic transducer unit 40 for conversion of the electronic signal to an acoustic signal. In addition, the microcontroller 22 receives electronic signals from the acoustic transducer unit 40, which may be processed to determine vessel location and bearing.

Together, the acoustic transceiver unit 20 and the acoustic transducer unit 40 generate the outgoing acoustic interrogation signals 41 that propagate from the surface vessel to any seafloor platforms 60 within range of the surface component 10. The outgoing acoustic interrogation signal 41 may be either a simple acoustic signal or a coded acoustic signal.

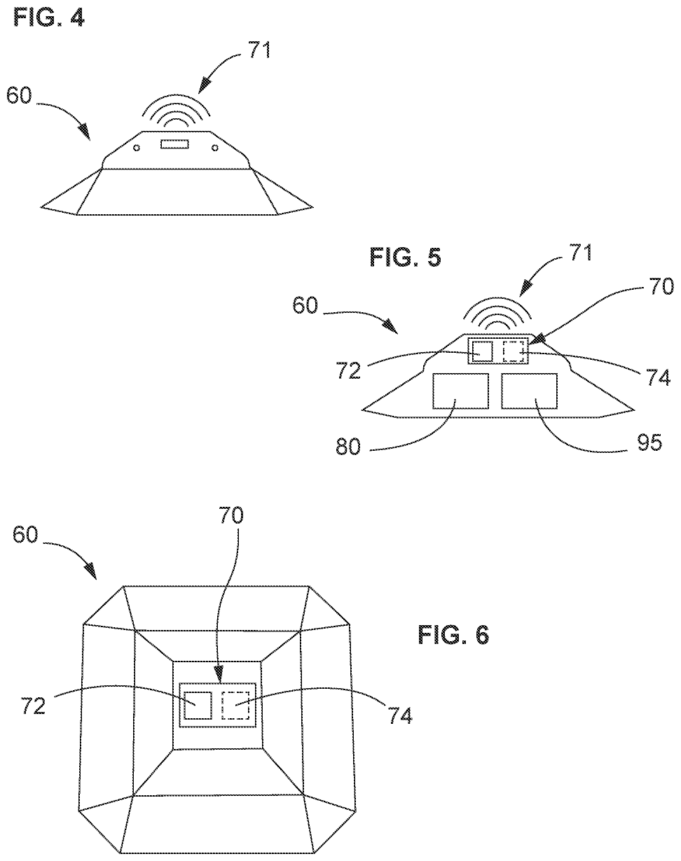

The subsurface component 50 is comprised of a plurality of seafloor platforms 60, each seafloor platform is placed at a known geodetic location on the seafloor and each seafloor platform 60 may be assigned a unique identifier. As shown in FIGS. 4-6, each seafloor platform 60 includes an acoustic transducer unit 70, an acoustic signal processing unit 80 and an energy source 95. Preferably, the energy source 95 is a battery. The acoustic transducer unit 70 performs the function of receiving incoming acoustic interrogation signals 41 and transmitting outgoing acoustic reply signals 71 and is in electronic communication with the acoustic signal processing unit 80. In some embodiments, the acoustic transducer unit 70 may include a single transducer 72 that performs the receive function with regard to incoming interrogation signals 41 and the transmit function with regard to outgoing reply signals 71. Alternatively, the acoustic transducer unit 70 may include a first transducer 72, which performs the receive function, and a second transducer 74, which performs the transmit function. Regardless of the number of transducers, the acoustic transducer unit 70 may perform both the transmit function and the receive function omnidirectionally.

The acoustic transducer unit 70 is in electronic communication with the acoustic signal processing unit 80. The acoustic signal processing unit 80 is comprised of a microcontroller and one or more electronic components that process the electronic signals received from the acoustic transducer unit 70. Upon receiving an electrical signal from the acoustic transducer unit 70, the acoustic signal processing unit 80 generates an electronic reply signal that is sent to the acoustic transducer unit 70, converted into an acoustic reply signal 71, and the acoustic reply signal 71 is then transmitted into the water. The electronic reply signal, and the resulting acoustic reply signal 71, is preferably a coded acoustic signal that identifies the specific seafloor platform 60 and enables the surface component 10 to determine the geodetic location of the seafloor platform 60. Alternative, the electronic reply signal, and the resulting acoustic reply signal 71, may be a coded acoustic signal that identifies the geodetic location of the specific seafloor platform 60.

In one embodiment of the acoustic navigation system 100, the subsurface component 50 comprises a pair of seafloor platforms 60 separated by a known, fixed distance. When the surface component 10 transmits an acoustic interrogation signal 41 within range of the pair of seafloor platforms 60, each seafloor platform 60 will receive the acoustic interrogation signal 41 and produce its own acoustic reply signal 71. The acoustic reply signal 71 transmitted by each seafloor platform 60 includes: (i) the unique identifier of the seafloor platform 60; (ii) the geodetic location of the seafloor platform 60; or (iii) both the unique identifier of the seafloor platform 60 and the geodetic location of the seafloor platform 60. For example, the acoustic reply signal 71 may include the seafloor platform 60 identifier, which can be used by the surface component 10 to match a known seafloor platform 60 positioned at a known geodetic location. Alternatively, the acoustic reply signal 71 may incorporate the geodetic location of the seafloor platform 60 into the acoustic reply signal 71.

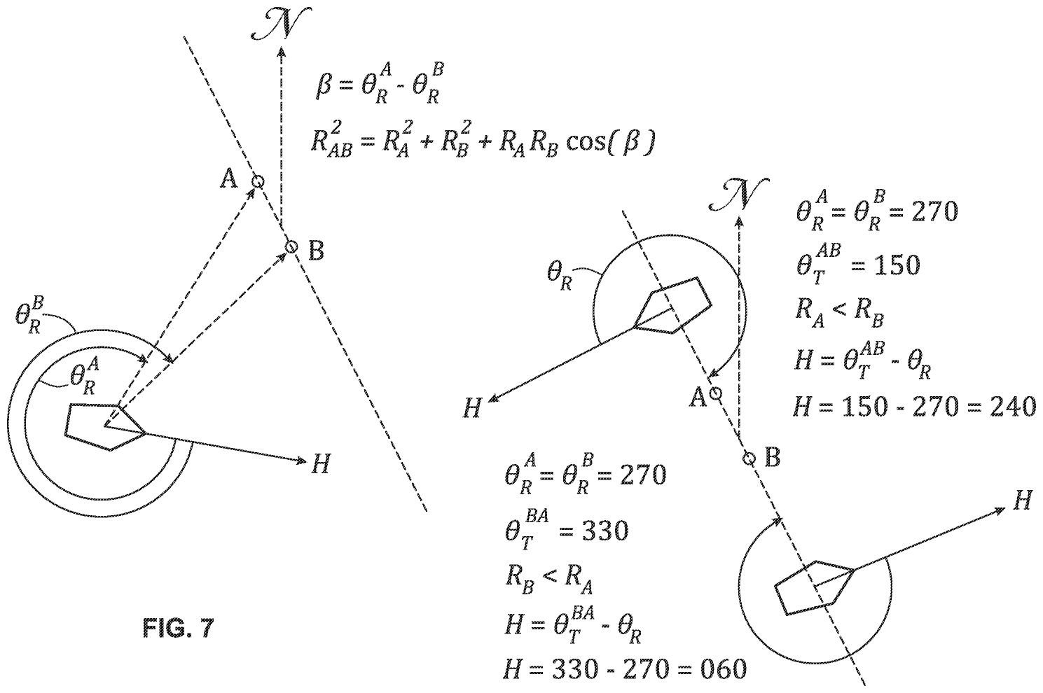

The acoustic reply signal 71 is received by the surface component via the acoustic transducer unit 40. As shown in FIG. 7, the acoustic reply signal 71 provides sufficient information to determine the location of the surface vessel. For example, because the fixed geodetic location of each seafloor platform 60 is known, the acoustic reply signals 71 can be used to calculate the geodetic location of the surface vessel. Further, utilizing a directional transducer 42, 43 for the receive function allows the acoustic transceiver unit 20 to utilize the acoustic reply signals 71 to calculate both geodetic location and vessel heading.

The acoustic transducer unit 40 utilizes a directional transducer 42, 43 to receive the acoustic reply signals 71. Although the acoustic navigation system 100 can function using an omnidirectional transducer 42, 43 for the receive function of the surface component 10, such an arrangement introduces potential errors in the calculation of the surface vessel's geodetic location. For example, using an omnidirectional transducer 42, 43 for the receive function will generate an ambiguity regarding which side of the seafloor platforms 60 the surface vessel lies on. In addition, when the surface vessel lies on the line between the pair of seafloor platforms 60, the use of an omnidirectional transducer 42, 43 for the receive function results in the inability to calculate position due to irreconcilable mathematical errors.

By utilizing a directional transducer 42, 43 for the receive function, the deficiencies noted above regarding ambiguities and blind spots are resolved. In addition, the use of a directional transducer 42, 43 provides additional benefits, including facilitating the calculation of the heading of the surface vessel by using the equations identified in FIG. 7.

Once the acoustic transceiver unit 40 calculates the geodetic location of the vessel and vessel heading, this information can be displayed on a human machine interface 25. The vessel's geodetic location and heading information can be displayed as raw data, such as the calculated latitude and longitude and the heading in degrees. Alternatively, the vessel's geodetic location and heading may be displayed graphically on a human machine interface 25 such as an electronic charting display.

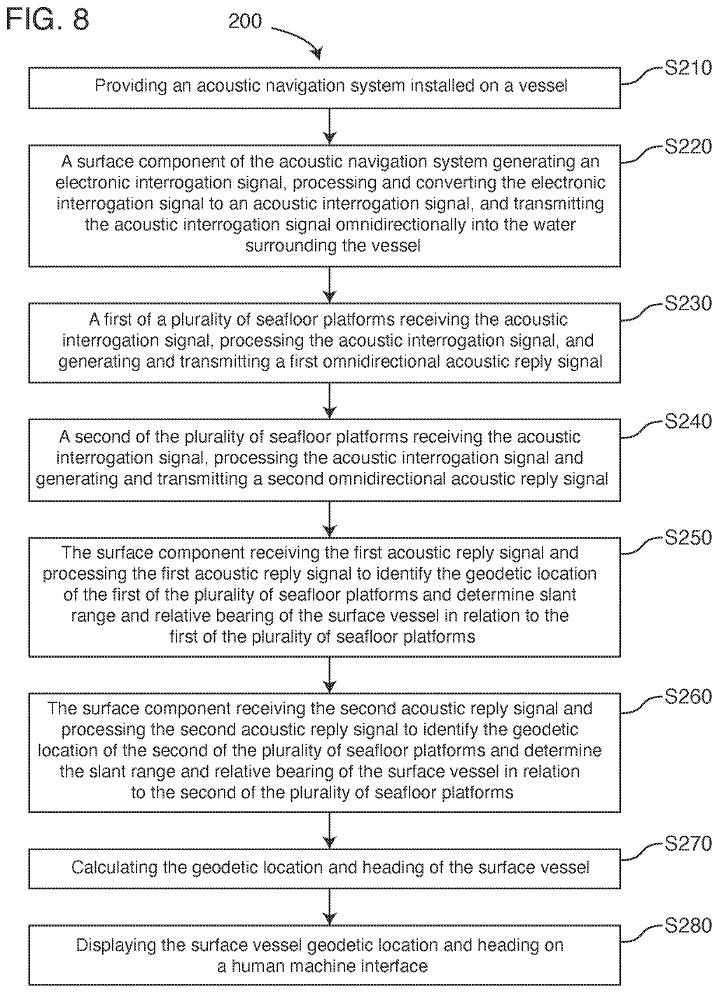

Turning to FIG. 8, a method 200 of using the acoustic navigation system 100 of the present invention is shown. A first step S210 includes providing an acoustic navigation system 100 comprising a surface component 10 installed on a vessel, the surface component 10 comprising a surface acoustic transducer unit 40 and an acoustic transceiver unit 20, with the surface component 10 configured to generate and transmit an omnidirectional acoustic interrogation signal 41; a subsurface component 50 comprising a plurality of seafloor platforms 60 placed at known geodetic locations on the seafloor, the plurality of seafloor platforms 60 each comprising a subsurface acoustic transducer unit 70, an acoustic signal processing unit 80, and an energy source 95. Each of the plurality of seafloor platforms 60 configured to receive and process the acoustic interrogation signals 41 and to generate and transmit an omnidirectional acoustic reply signal 71. The surface component 10 further configured to receive and process the acoustic reply signal 71 transmitted by any of the plurality of seafloor platforms 60, to calculate the geodetic location and heading of the vessel, and to display the geodetic location and heading of the vessel on a human machine interface 25. A second step S220 includes the surface component 10 generating an electronic interrogation signal, processing the electronic interrogation signal with the acoustic transceiver unit 20 and passing the electronic interrogation signal to the surface acoustic transducer unit 40, converting the electronic interrogation signal to an acoustic interrogation signal, and transmitting the acoustic interrogation signal 41 omnidirectionally into the water surrounding the vessel. A third step S230 includes a first of the plurality of seafloor platforms 60 receiving the acoustic interrogation signal 41, processing the acoustic interrogation signal 41 and generating and transmitting a first omnidirectional acoustic reply signal 71. A fourth step S240 includes a second of the plurality of seafloor platforms 60 receiving the acoustic interrogation signal 41, processing the acoustic interrogation signal 41 and generating and transmitting a second omnidirectional acoustic reply signal 71. A fifth step S250 includes the surface component 10 receiving the first acoustic reply signal 71 and processing the first acoustic reply signal 71 to identify the geodetic location of the first of the plurality of seafloor platforms 60 and determine slant range and relative bearing of the surface vessel in relation to the first of the plurality of seafloor platforms 60. A sixth step S260 includes the surface component 10 receiving the second acoustic reply signal 41 and processing the second acoustic reply signal 41 to identify the geodetic location of the second of the plurality of seafloor platforms 60 and determine the slant range and relative bearing of the surface vessel in relation to the second of the plurality of seafloor platforms 60. A seventh step S270 includes calculating the geodetic location and heading of the surface vessel. An eighth step S280 includes displaying the surface vessel geodetic location and heading on the human machine interface 25.

It is noted that the foregoing examples have been provided merely for the purpose of explanation and are in no way to be construed as limiting of the present invention. While the present invention has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. An acoustic navigation system comprising:
a surface component installed on a vessel, the surface component comprising a surface acoustic transducer unit and an acoustic transceiver unit;
the surface component configured to generate and transmit an omnidirectional acoustic interrogation signal;
a subsurface component comprising a plurality of seafloor platforms placed at known geodetic locations on the seafloor, the plurality of seafloor platforms each comprising a subsurface acoustic transducer unit, an acoustic signal processing unit and an energy source;
each of the plurality of seafloor platforms configured to receive and process the acoustic interrogation signals and to generate and transmit an omnidirectional acoustic reply signal;
the surface component further configured to receive and process the acoustic reply signal transmitted by each seafloor platform, to calculate the geodetic location and heading of the vessel, and to display the geodetic location and heading of the vessel on a human machine interface.

2. The acoustic navigation system of claim 1, wherein the surface acoustic transceiver unit comprises a directional transducer.

3. The acoustic navigation system of claim 1, wherein the omnidirectional acoustic reply signal is a coded acoustic signal.

4. The acoustic navigation system of claim 3, wherein the coded acoustic signal identifies the one of the plurality of seafloor platforms that generated and transmitted the omnidirectional acoustic reply signal.

5. The acoustic navigation system of claim 3, wherein the coded acoustic signal identifies the geodetic location of the one of the plurality of seafloor platforms that generated and transmitted the omnidirectional acoustic reply signal.

6. A method of using an acoustic navigation system comprising:
a. providing an acoustic navigation system comprising:
i. a surface component installed on a vessel, the surface component comprising a surface acoustic transducer unit and an acoustic transceiver unit;
ii. the surface component configured to generate and transmit an omnidirectional acoustic interrogation signal;
iii. a subsurface component comprising a plurality of seafloor platforms placed at known geodetic locations on the seafloor, the plurality of seafloor platforms each comprising a subsurface acoustic transducer unit, an acoustic signal processing unit and an energy source;
iv. each of the plurality of seafloor platforms configured to receive and process the acoustic interrogation signals and to generate and transmit an omnidirectional acoustic reply signal;
v. the surface component further configured to receive and process the acoustic reply signal transmitted by any of the plurality of seafloor platforms, to calculate the geodetic location and heading of the vessel, and to display the geodetic location and heading of the vessel on a human machine interface;
b. the surface component generating an electronic interrogation signal, processing the electronic interrogation signal with the acoustic transceiver unit, and passing the electronic interrogation signal to the surface acoustic transducer unit, converting the electronic interrogation signal to an acoustic interrogation signal, and transmitting the acoustic interrogation signal omnidirectionally into the water surrounding the vessel;
c. a first of the plurality of seafloor platforms receiving the acoustic interrogation signal, processing the acoustic interrogation signal, and generating and transmitting a first omnidirectional acoustic reply signal;
d. a second of the plurality of seafloor platforms receiving the acoustic interrogation signal, processing the acoustic interrogation signal, and generating and transmitting a second omnidirectional acoustic reply signal;
e. the surface component receiving the first acoustic reply signal and processing the first acoustic reply signal to identify the geodetic location of the first of the plurality of seafloor platforms and determine slant range and relative bearing of the surface vessel in relation to the first of the plurality of seafloor platforms;
f. the surface component receiving the second acoustic reply signal and processing the second acoustic reply signal to identify the geodetic location of the second of the plurality of seafloor platforms and determine the slant range and relative bearing of the surface vessel in relation to the second of the plurality of seafloor platforms;
g. calculating the geodetic location and heading of the surface vessel; and
h. displaying the surface vessel geodetic location and heading on the human machine interface.

7. The method of acoustic navigation of claim 6, wherein the first acoustic reply signal and the second acoustic reply signal are each coded acoustic signals.

8. The method of acoustic navigation of claim 7, wherein the first acoustic reply signal identifies the first of the plurality of seafloor platforms and the second acoustic reply signal identifies the second of the plurality of seafloor platforms.

9. The acoustic navigation system of claim 7, wherein the first acoustic reply signal identifies the geodetic location of the first of the plurality of seafloor platforms and the second acoustic reply signal identifies the geodetic location of the second of the plurality of seafloor platforms.
